(19) United States
(12) Patent Application Publication
(10) Pub. No.: US 2017/0299797 A1
(43) Pub. Date: Oct. 19, 2017

(54) LIGHTING ASSEMBLY WITH DIFFERING LIGHT OUTPUT DISTRIBUTION AND/OR SPECTRUM OUTPUT

(71) Applicant: Rambus Delaware LLC, Sunnyvale, CA (US)

(72) Inventors: Robert Ezell, Brunswick, OH (US); Kurt Starkey, Strongsville, OH (US)

(21) Appl. No.: 15/488,656

(22) Filed: Apr. 17, 2017

Related U.S. Application Data
(60) Provisional application No. 62/323,345, filed on Apr. 15, 2016.

(51) Int. Cl. F21V 8/00; H05B 33/08

(52) U.S. Cl. CPC G02B 6/0055; H05B 33/0845; G02B 6/0078; G02B 6/0088

(57) ABSTRACT

A lighting assembly includes a light guide having opposed major surfaces, a light input edge extending between the major surfaces and including first and second input regions, a first light guide region associated with the first input region and including first light extracting elements, and a second light guide region associated with the second input region and including second light extracting elements. A first light source segment is arranged to input light through the first input region and into the first light guide region, and a second light source segment is arranged to input light through the second input region and into the second light guide region. The first light source segment and the second light source segment are independently controllable to control an illumination state of the solid-state light emitters

### RELATED APPLICATION DATA

This application claims the benefit of U.S. Provisional Patent Application No. 62/323,345, filed Apr. 15, 2016, the disclosure of which is incorporated herein by reference in its entirety.

### BACKGROUND

Energy efficiency has become an area of interest for energy consuming devices. One class of energy consuming devices is lighting devices. Light emitting diodes (LEDs) show promise as energy efficient light sources for lighting devices. But control over light output by lighting devices that use LEDs or similar light sources can be an issue, particularly in implementations that demand versatility with respect to light output distribution and/or spectrum output.

### SUMMARY

In accordance with one aspect of the present disclosure, a lighting assembly includes a light guide including: a first major surface; a second major surface opposed the first major surface; at least one light input edge extending between the first major surface and the second major surface, the first major surface and the second major surface configured to propagate light input to the light guide through the at least one light input edge therebetween by total internal reflection, the at least one light input edge including a first light input region and a second light input region; a first light guide region including first light extracting elements at at least one of the major surfaces, the first light guide region configured to extract light input to the light guide through the first light input region; and a second light guide region including second light extracting elements at at least one of the major surfaces, the second light guide region configured to extract light input to the light guide through the second light input region; a light source adjacent the at least one light input edge, the light source including a first light source segment of solid-state light emitters and a second light source segment of solid-state light emitters, the first light source segment arranged to input light through the first light input region and into the first light guide region, the second light source segment arranged to input light through the second light input region and into the second light guide region, the first light source segment and the second light source segment independently controllable to control an illumination state of the solid-state light emitters.

In some embodiments, an ON/OFF state of the first light source segment is controlled independent of the ON/OFF state of the second light source segment.

In some embodiments, the first light source segment is dimmable independent of the second light source segment.

In some embodiments, an ON/OFF state of the respective solid-state light emitters within the first light source segment are controlled independent of one another and an ON/OFF state of the respective solid-state light emitters within the second light source segment are controlled independent of one another.

In some embodiments, respective solid-state light emitters within the first light source segment are dimmable and respective solid-state light emitters within the second light source segment are dimmable.

In some embodiments, the lighting assembly further includes a controller configured to selectively control the illumination state of the solid-state light emitters of first light source segment and the second light source segment.

In some embodiments, each of the solid-state light emitters emit light have nominally the same spectrum.

In some embodiments, the solid-state light emitters of the first light guide segment emit light at a different spectrum than the second group of solid-state light emitters.

In some embodiments, the solid-state light emitters of the first group emit light at different respective spectrums.

In some embodiments, the first light source segment includes solid-state light emitters configured to emit light at about 400 nm to about 500 nm, and the second light source segment includes solid-state light emitters configured to emit light at about 600 nm to about 700 nm.

In some embodiments, the first light extracting elements of the first light guide region are configured to output light in a first light output distribution, and the second light extracting elements of the second light guide region are configured to output light in a second light output distribution different than the first light output distribution.

In some embodiments, the first light extracting elements of the first light guide region and the light extracting elements of the second light guide region are configured to output light in nominally the same light output distribution.

In some embodiments, the light guide includes a slot at least partially separating the first light guide region and the second light guide region. In some embodiments, the lighting assembly further includes a reflective material disposed in the slot.

In some embodiments, the light guide includes light guide segments, one of the light guide segments includes the first light guide region and another of the light guide segments includes the second light guide region.

In some embodiments, the first light guide region is adjacent the second light guide region, and each of the first light guide region and the second light guide region extend from the light input edge to an end edge opposite the light input edge.

In some embodiments, the first light guide region at least partially surrounds the second light guide region.

In some embodiments, the first light guide region at least partially overlaps the second light guide region.

In some embodiments, the lighting assembly further includes a housing configured to retain the light guide, wherein the light guide is removably attached to the housing.

In some embodiments, the lighting assembly further includes a cover element adjacent one of the major surfaces of the light guide, the cover element including a first cover element region aligned with the first light guide region and a second cover element region aligned with the second light guide region, at least one of the first and second cover element regions configured to impart an optical modifying characteristic to the light extracted from the light guide.

### BRIEF DESCRIPTION OF THE DRAWINGS

FIG. 1 is a schematic perspective view of parts of an exemplary lighting assembly.

FIGS. 2 and 3 are schematic views of exemplary micro-optical elements.

FIGS. 4-11 are schematic views of parts of exemplary lighting assemblies.

FIG. 12 is a schematic perspective view of an exemplary light guide.

FIG. 13 is a schematic view of an exemplary lighting assembly.

FIG. 13A is a schematic view of an exemplary lighting assembly.

FIG. 14 is a schematic perspective view of an exemplary light guide.

FIGS. 15-22 are schematic views of parts of exemplary lighting assemblies.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface (e.g., the major surface).

The present disclosure sets forth lighting assemblies that may provide versatility with respect to light output distribution and/or spectrum output. This may make the lighting assemblies of the present disclosure particularly applicable to implementations where such versatility is needed. One exemplary implementation is in the area of plant growth (i.e., grow lights), where lighting assemblies of the present disclosure may be controlled to provide different light output distributions and/or spectrum output during different stages of plant growth and development, and/or during different times of the day. Another example is in the medical field (e.g., an examination room or operating room), where lighting assemblies of the present disclosure may be controlled to provide, for example, a diffuse warm light output distribution throughout the room; and may also be controlled to provide, for example, a more directional distribution of cooler light that can be used to provide lighting during examinations and other tasks that require higher levels of lighting. Other examples include implementations of general or architectural lighting (e.g., a conference room), where lighting assemblies of the present disclosure may be controlled to provide different light output distributions depending on how the meeting room is being utilized (e.g., a presentation, a board meeting, etc.).

In accordance with one aspect of the present disclosure, a lighting assembly includes a light guide including a first major surface; a second major surface opposed the first major surface; at least one light input edge extending between the first major surface and the second major surface, the first major surface and the second major surface configured to propagate light input to the light guide through the at least one light input edge therebetween by total internal reflection, the at least one light input edge including a first light input region and a second light input region; a first light guide region including first light extracting elements at at least one of the major surfaces, the first light guide region associated with the first light input region and configured to extract light input to the light guide through the first light input region; and a second light guide region including second light extracting elements at at least one of the major surfaces, the second light guide region associated with the second light input region and configured to extract light input to the light guide through the second light input region; a light source adjacent the at least one light input edge, the light source including a first light source segment of solid-state light emitters and a second light source segment of solid-state light emitters, the first light source segment arranged to input light through the first light input region and into the first light guide region, the second light source segment arranged to input light through the second light input region and into the second light guide region, the first light source segment and the second light source segment independently controllable to control an illumination state of the solid-state light emitters.

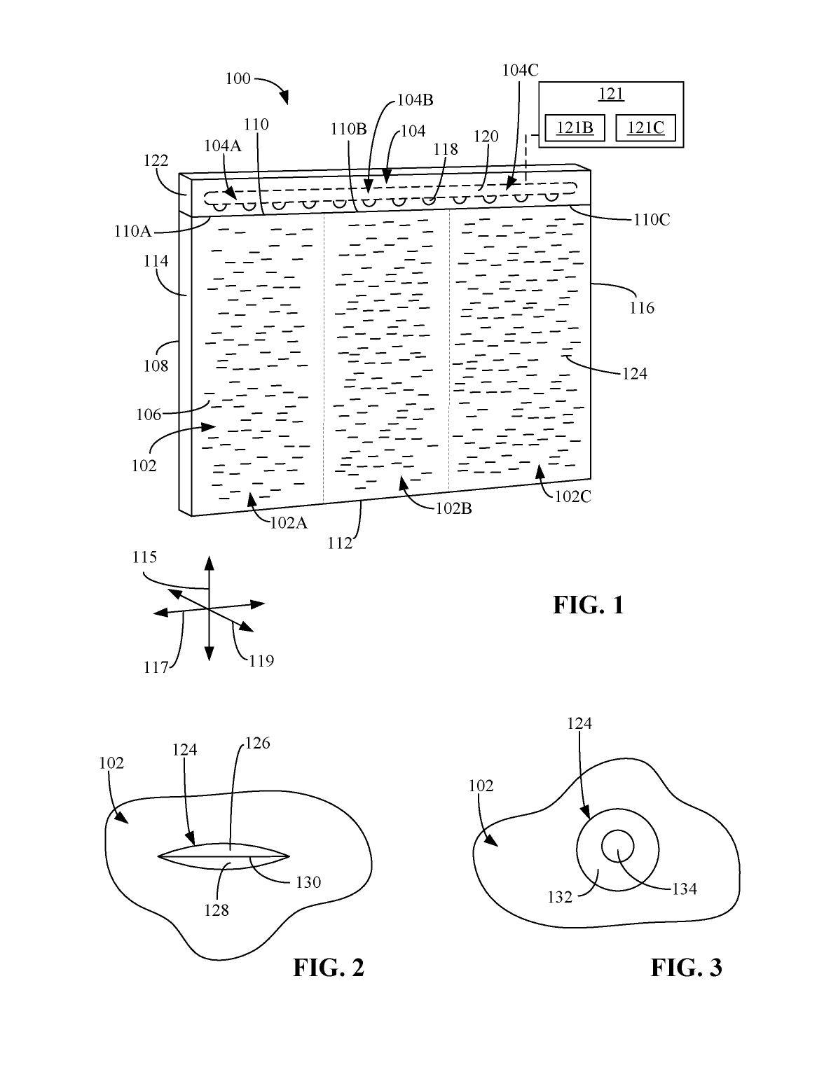

With initial reference to FIG. 1, an exemplary embodiment of a lighting assembly is shown at 100. The lighting assembly 100 includes a light guide 102. The light guide 102 is a solid article of manufacture (e.g., a substrate) made from, for example, polycarbonate, poly(methyl-methacrylate) (PMMA), glass, or other appropriate material. The light guide 102 may also be a multi-layer light guide having two or more layers that may differ in refractive index. The light guide 102 includes a first major surface 106 and a second major surface 108 opposite the first major surface 106. The light guide 102 is configured to propagate light by total internal reflection between the first major surface 106 and the second major surface 108. The length and width dimensions of each of the major surfaces 106, 108 are greater, typically ten or more times greater, than the thickness of the light guide 102. The thickness is the dimension of the light guide 102 in a direction orthogonal to the major surfaces 106, 108 (i.e., thickness direction 119). The thickness of the light guide 102 may be, for example, about 0.1 millimeters (mm) to about 10 mm.

At least one edge surface extends between the major surfaces 106, 108 of the light guide in the thickness direction. The total number of edge surfaces depends on the configuration of the light guide. In the case where the light guide is rectangular (e.g., as exemplified in FIG. 1), the light guide has four edge surfaces 110, 112, 114, 116. In the embodiment shown, the light guide extends in a first direction 115 (e.g., a length direction) between edge surface 110 and edge surface 112; and extends in a second direction 117 (e.g., a width direction) orthogonal to the first direction 115 between edge surface 114 and edge surface 116. Other light guide shapes result in a corresponding number of side edges. Although not shown, in some embodiments, the light guide 102 may additionally include one or more edge surfaces defined by the perimeter of an orifice extending through the light guide in the thickness direction. Each edge surface defined by the perimeter of an orifice extending through the light guide 102 will hereinafter be referred to as an internal edge surface. Depending on the shape of the light guide 102, each edge surface may be straight or curved, and adjacent edge surfaces may meet at a vertex or join in a curve. Moreover, each edge surface may include one or more straight portions connected to one or more curved portions. The edge surface through which light from the light source 104 is input to the light guide will now be referred to as a light input edge. In the embodiment shown in FIG. 1, the edge surface 110 is a light input edge. In some embodiments, the light guide 102 includes more than one light input edge. For example, the light source may also be present at the edge surface 112 opposite the edge surface 110. In another example, the light source may also be present at the edge surface 116. Furthermore, the one or more light input edges may be straight and/or curved.

In the embodiment shown in FIG. 1, the major surfaces 106, 108 are planar. In other embodiments, at least a portion of the major surfaces 106, 108 of the light guide 102 is curved in one or more directions. In one example, the intersection of the light input edge 110 and one of the major surfaces 106, 108 defines a first axis, and at least a portion of the light guide 102 curves about an axis parallel to the first axis. In another example, at least a portion of the light guide 102 curves about an axis orthogonal to the first axis. Other exemplary shapes of the light guide include a semi-cylindrical body, a dome, a hollow cylinder, a hollow cone or pyramid, a hollow frustrated cone or pyramid, a bell shape, an hourglass shape, or another suitable shape.

With continued reference to FIG. 1, the lighting assembly 100 includes a light source 104 positioned adjacent the light input edge 110. The light source 104 is configured to edge light the light guide 102 such that light from the light source 104 enters the light input edge 110 and propagates along the light guide 102 by total internal reflection at the major surfaces 106, 108. In embodiments where the light guide includes more than one light input edge or light input edge segments (e.g., 110A, 110B, and 110C as shown in FIG. 1), the light source 104 may include two or more light source segments (e.g., 104A, 104B, and 104C as shown in FIG. 1) that collectively form the light source 104.

The light source 104 may include one or more solid-state light emitters 118. The solid-state light emitters 118 constituting the light source 104 are arranged linearly or in another suitable pattern depending on the shape of the light input edge of the light guide 102 to which the light source 104 supplies light. Exemplary solid-state light emitters 118 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 118 emit light with no operably-effective intensity at wavelengths greater than 500 nanometers (nm) (i.e., the solid-state light emitters 118 emit light at wavelengths that are predominantly less than 500 nm). In some embodiments, the solid-state light emitters 118 constituting light source 104 all generate light having the same nominal spectrum. The term “nominally” as used herein encompasses variations of one or more parameters that fall within acceptable tolerances in design and/or manufacture. In other embodiments, at least some of the solid-state light emitters 118 constituting light source 104 generate light that differs in spectrum from the light generated by the remaining solid-state light emitters 118. For example, the light source may include light source segments including groupings of solid-state light emitters, each of the solid-state light emitters in a given light source segment generating a particular spectrum that may be different from the particular spectrum generated by the solid-state light emitters of another one of the light source segments. In another example, the light source may include light source segments including groupings of solid-state light emitters, wherein at least a portion of the solid-state light emitters within a given light source segment may generate light at a spectrum that is different than the other solid-state light emitters within the given light source segment. As described in more detail below, the light source segments and the solid-state light emitters within the respective light source segments may be controlled by controller 121.

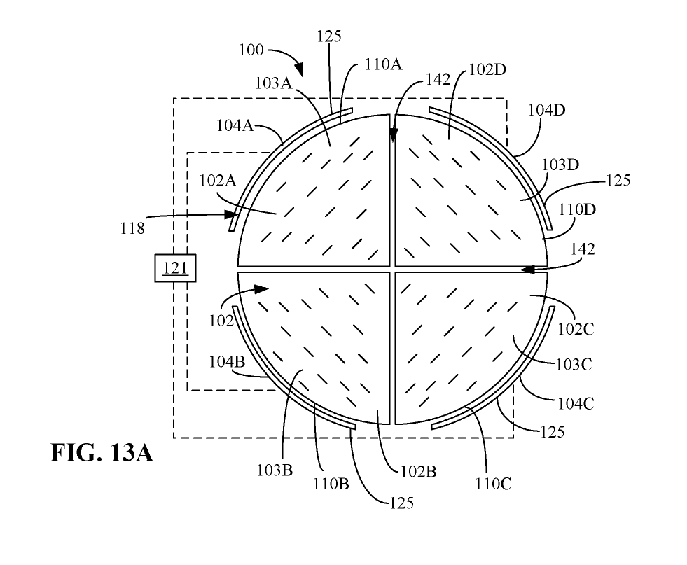

The lighting assembly 100 may include one or more additional components. For example, although not specifically shown in detail, in some embodiments of the lighting assembly, the light source 104 includes structural components to retain the solid-state light emitters 118. In the example shown in FIG. 1, the solid-state light emitters 118 may be mounted to one or more printed circuit boards (PCB) 120. In other embodiments, the solid-state light emitters 118 may be mounted to a substrate such as a flexible and/or conformable substrate (FIG. 13A, element 125). The light source 104 may additionally include circuitry, power supply, electronics for controlling and driving the solid-state light emitters 118, and/or any other appropriate components. In the example shown in FIG. 1, the lighting assembly 100 includes a controller 121 for controlling operation (the illumination state) of the solid-state light emitters 118. In some exemplary embodiments, the controller 121 may include a processor 121B for executing one or more programs stored in a non-transitory computer readable medium (e.g. memory 121C) for providing the functionality and overall operation of the control; and the controller may selectively control the illumination state of the solid-state light emitters of light source segments based on one or more inputs such as user input, environmental conditions (e.g., temperature, ambient brightness), time of day, time of year, etc. In other exemplary embodiments, the controller 121 may be embodied as one or more ON/OFF buttons or switches, dimmer switches, and the like that may be manually controlled by a user of the device.

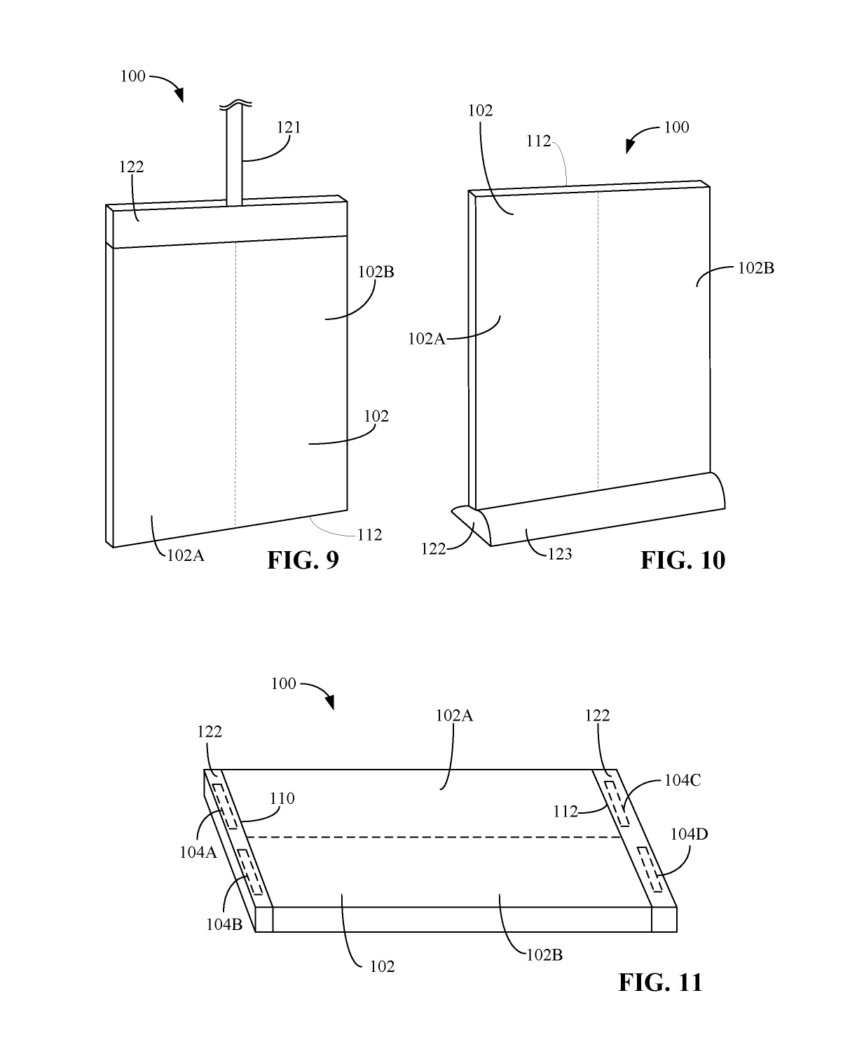

The lighting assembly 100 may include a housing 122 for retaining the light source 104 and the light guide 102. The housing 122 may retain a heat sink or may itself function as a heat sink. In some embodiments, the lighting assembly 100 includes a mounting mechanism to mount the lighting assembly to a retaining structure (e.g., a ceiling, a wall, etc.). For example, FIG. 9 shows an exemplary embodiment of a lighting assembly including a pole 121 attached to the housing 122 for mounting the lighting assembly to the retaining structure. In other embodiments, and with reference to FIG. 10, the lighting assembly may include a base (stand) 123 for retaining the lighting assembly in a vertical orientation. The base 123 may be attached to the housing 122 or the housing may be shaped such that it itself forms the base.

The lighting assembly 100 may include a reflector (not shown) adjacent at least a portion of at least one of the major surfaces 106, 108. The reflector may be a specular reflector, a diffuse reflector, or a patterned reflector. The light extracted through the major surface adjacent the reflector may be reflected by the reflector, re-enter the light guide 102 at the major surface, and be output from the light guide 102 through the other major surface.

With continued reference to FIG. 1, the light guide 102 includes light extracting elements 124 in, on, or beneath at least one of the major surfaces 106, 108. Light extracting elements that are in, on, or beneath a major surface will be referred to as being “at” the major surface. In FIG. 1, the light extracting elements 124 are generically shown as being at the first major surface 106. The reference numeral 124 will be generally used to collectively refer to the different embodiments of light extracting elements. While the light extracting elements 124 are generically shown in FIG. 1 as dashes, it will be understood that the light extracting elements can respectively have one or more specific configurations, such as those described below.

Each light extracting element 124 functions to disrupt the total internal reflection of the light propagating in the light guide and incident thereon. In one embodiment, the light extracting elements 124 reflect light toward the opposing major surface so that the light exits the light guide 102 through the opposing major surface. Alternatively, the light extracting elements 124 transmit light through the light extracting elements 124 and out of the major surface of the light guide 102 having the light extracting elements 124. In another embodiment, both types of light extracting elements 124 are present. In yet another embodiment, the light extracting elements 124 reflect some of the light and refract the remainder of the light incident thereon, and therefore the light extracting elements 124 are configured to extract light from the light guide 102 through one or both of the major surfaces 106, 108.

Exemplary light extracting elements 124 include light-scattering elements, which are typically features of indistinct shape or surface texture, such as printed features, ink-jet printed features, selectively-deposited features, chemically etched features, laser etched features, and so forth. Other exemplary light extracting elements 124 include features of well-defined shape, such as grooves (e.g., V-grooves and/or truncated V-grooves) that are recessed into or protrude from the major surface. Other exemplary light extracting elements 124 include micro-optical elements, which are features of well-defined shape that are small relative to the linear dimensions of the major surfaces 106, 108. The smaller of the length and width of a micro-optical element is less than one-tenth of the longer of the length and width (or circumference) of the light guide 102 and the larger of the length and width of the micro-optical element is less than one-half of the smaller of the length and width (or circumference) of the light guide 102. The length and width of the micro-optical element is measured in a plane parallel to the major surface 106, 108 of the light guide 102 for planar light guides or along a surface contour for non-planar light guides 102.

Light extracting elements 124 of well-defined shape (e.g., the above-described grooves and micro-optical elements) are shaped to predictably reflect and/or refract the light propagating in the light guide 102. In some embodiments, at least one of the light extracting elements 124 is an indentation (depression) of well-defined shape in the major surface 106, 108. In other embodiments, at least one of the light extracting elements 124 is a protrusion of well-defined shape from the major surface 106, 108. The light extracting elements of well-defined shape have distinct surfaces on a scale larger than the surface roughness of the major surfaces 106, 108. Light extracting elements of well-defined shape exclude features of indistinct shape or surface textures, such as printed features of indistinct shape, ink-jet printed features of indistinct shape, selectively-deposited features of indistinct shape, and features of indistinct shape wholly formed by chemical etching or laser etching.

The light extracting elements 124 are configured to extract light in a defined intensity profile (e.g., a uniform intensity profile) and with a defined light ray angle distribution from one or both of the major surfaces 106, 108. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface. Each light extracting element 124 of well defined shape includes at least one surface configured to refract and/or reflect light propagating in the light guide 102 and incident thereon such that the light is extracted from the light guide. Such surface(s) is also herein referred to as a light-redirecting surface.

Exemplary micro-optical element shapes include cones, truncated cones, pyramids, truncated pyramids, and football shapes. FIG. 2 shows an exemplary embodiment of a light extracting element 124 embodied as a football-shaped micro-optical element at a major surface of a light guide 102, which is configured as v-groove-shaped depression having an arcuate ridge. This football-shaped micro-optical element may alternatively be configured as a v-groove-shaped protrusion with an arcuate ridge. The football-shaped micro-optical element 124 includes a first side surface 126 and a second side surface 128 that come together to form a ridge 130 having ends that intersect the major surface at which the micro-optical element 124 is formed. FIG. 3 shows an exemplary embodiment of a light extracting element 124 embodied as a frustoconical-shaped micro-optical element 124 at a major surface of a light guide 102. The frustoconical-shaped micro-optical element 124 includes a side surface 132 and an end surface 134. The frustoconical-shaped micro-optical element may be a depression or protrusion at the major surface. Other exemplary light extracting elements 124 may have other suitable shapes. Exemplary micro-optical elements are described in U.S. Pat. No. 6,752,505, the entire content of which is incorporated by reference, and, for the sake of brevity, are not described in detail in this disclosure.

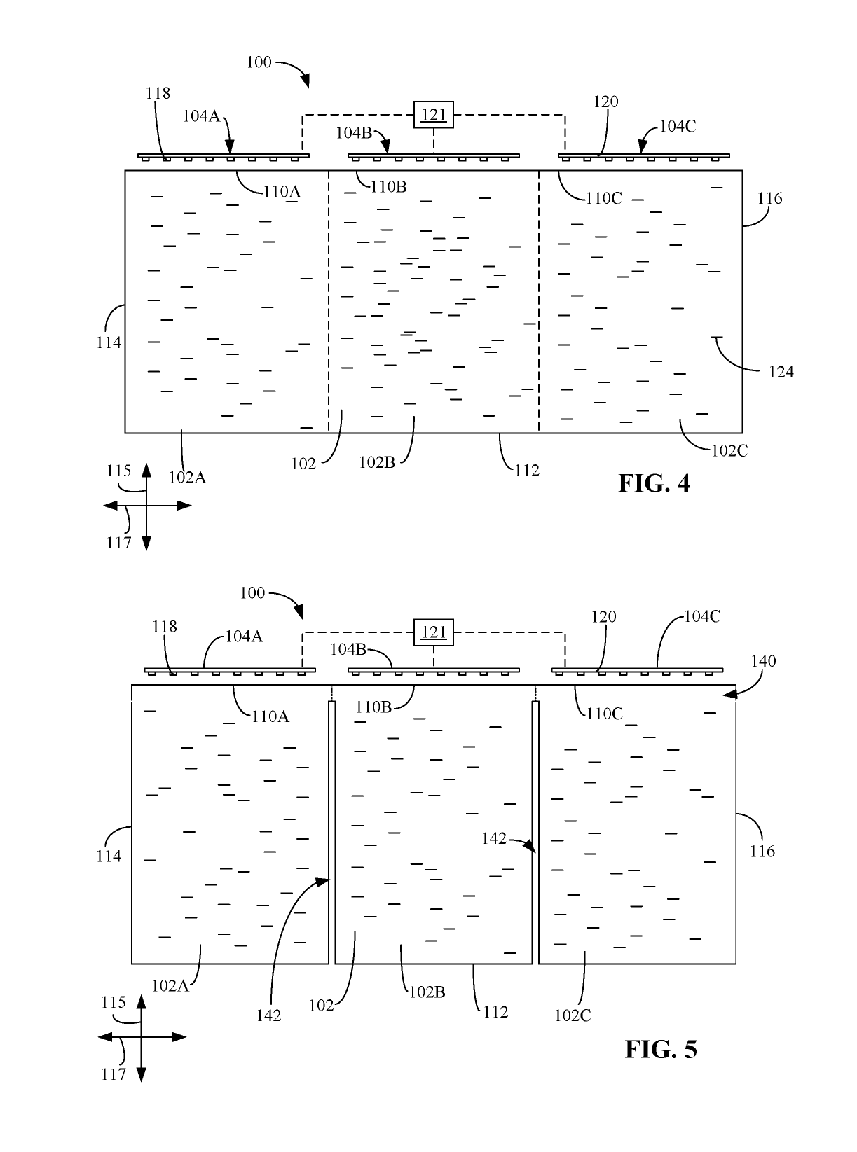

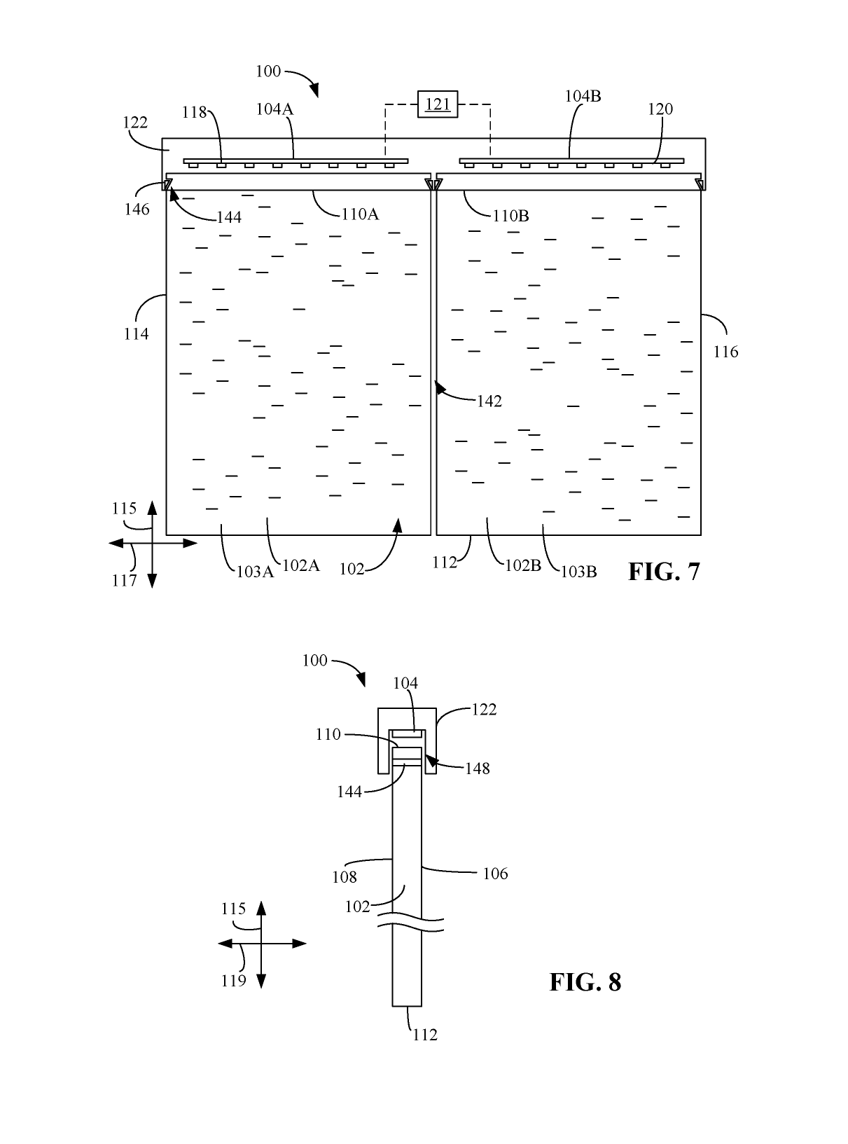

With continued reference to FIG. 1 and additional reference to FIG. 4, the light guide 102 includes distinct light guide regions (e.g., zones). Each light guide region includes light extracting elements 124. The exemplary embodiment shown in FIGS. 1 and 4 includes three light guide regions 102A, 102B, 102C (e.g., Zone 1, Zone 2, and Zone 3). Each light guide region is provided over a defined width (in direction 117) of the light guide and can be lit selectively by controlling different segments of the light source 104. In the example shown, each region also extends from the light input edge 110 to the end edge 112 of the light guide that is distal the light input edge 110. In embodiments where the light guide includes a transition region, each light guide region may include at least a portion of the transition region; or alternatively, each light guide region may extend from the end of the transition region along the direction 115 to the end edge of the light guide distal the light input edge. While three light guide regions 102A, 102B, 102C (first light guide region 102A, second light guide region 102B, third light guide region 102C) are shown in the example, it will be appreciated that other embodiments may include less than three regions (e.g., two regions, such as that shown in FIGS. 7-11) or more than three regions (e.g., four or more regions). In some embodiments, the light guide may include a repeating pattern of the light guide regions along the width (in direction 117) of the light guide (e.g., Zone 1, Zone 2, Zone 3, Zone 1, Zone 2, Zone 3, etc.).

In the embodiments shown, the sizes of the respective light guide regions are nominally the same. In other embodiments, the light guide regions of the light guide may be different respective sizes. Furthermore, in the embodiments shown, the respective light guide regions are shown at the major surface as rectangular regions. In other embodiments (e.g., such as those shown in FIGS. 13-16 and 21-24), the light guide regions may be configured in other suitable shapes at the major surface of the light guide.

In some embodiments, the light guide is a single (e.g., monolithic) element in which adjacent light guide regions abut one another. In the exemplary embodiments shown in FIGS. 1 and 4, the light guide continuously extends in the width direction 117 between the side edges 114, 116 and adjacent light guide regions share a border. The single (e.g., monolithic) element light guide may be formed as a single element, or may be formed by physically combining (e.g., gluing with optical adhesive) or abutting light guide segments. Accordingly, in some embodiments, there may be no element provided to physically separate the respective regions.

The light guide 102 may be configured such that the majority of light input to a given light guide region will propagate in and be extracted from that given light guide region. As an example, the light input regions of the light guide may include light input features (e.g., lenticular elements, not shown) in order to focus/direct the light in a given manner within an associated light guide region. As another example, the light extracting elements 124 of a given light guide region may be arranged to extract light input to the given light guide region (e.g., light propagating within a defined range of angles relative to perpendicular to the light input edge), while not extracting light crossing from one light guide region to another (e.g., light propagating outside a define range of angles relative to perpendicular to the light input edge). In some embodiments, at least 80% of the light input to a given light guide region is extracted from light extracting elements present in the given light guide region. In another example, at least 90% of the light input to a given light guide region is extracted from light extracting elements present in the given light guide region.

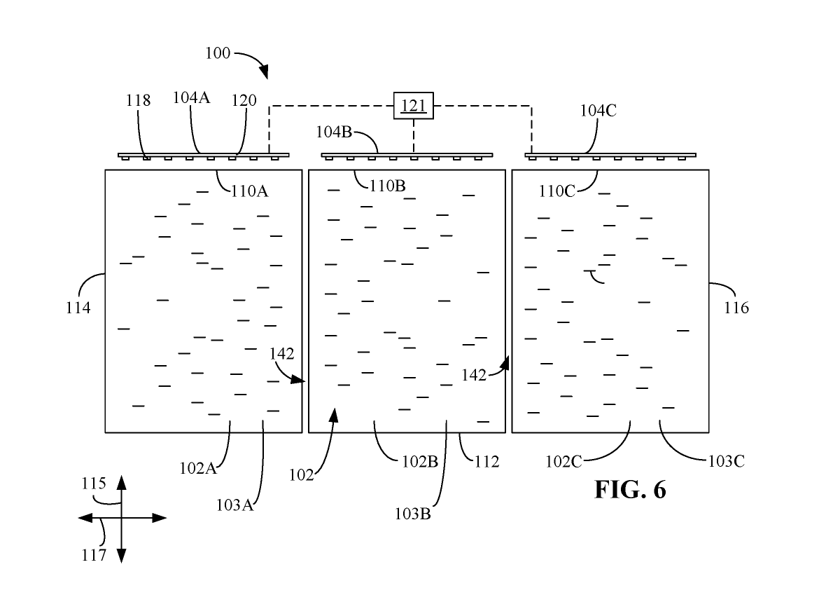

With reference to FIGS. 5 and 6, in some embodiments, adjacent light guide regions of the light guide may be at least partially separated from one another. In the exemplary embodiment shown in FIG. 5, the light guide 102 continuously extends between edge surfaces 114 and 116 at a transition region 140 proximate the light input edge, but the light guide regions extending from the transition region 140 are separated from one another in the width direction 117. A slot 142 is provided between respective adjacent zones. In the exemplary embodiment shown in FIG. 6, the light guide 102 is collectively formed by light guide segments 103A, 103B, 103C, with adjacent light guide segments completely separated from one another in the width direction by a slot 142. In FIG. 6, each light guide segment may constitute its own distinct light guide region 102A, 102B, 102C. In the embodiments shown in FIGS. 5 and 6, the slot 142 between adjacent light guide regions may be embodied as an air gap. Light input to and propagating in a given light guide region that is incident the edge surface adjacent the slot 142 may internally reflect and continue to propagate in the region. In some embodiments, an element such as a reflector or material having a different refractive index than the light guide regions may be disposed therein to redirect extracted light back into the light guide region.

Although not specifically shown, in some embodiments, one or more of the light guide segments 103A, 103B, 103C shown in FIG. 6 may include multiple light guide regions within each segment. For example, the repeating pattern of light guide regions (e.g., Zone 1, Zone 2, Zone 3, Zone 1, Zone 2, Zone 3, etc.) could be created by aligning multiple light guide segments adjacent to one another. As an example, each light guide segment shown in FIG. 6 may include regions such as that shown in FIG. 1. The adjacent light guide segments may be in contact with one another, may be spaced apart from one another by a gap, or may have an element such as a reflector material placed therebetween.

As exemplified in the embodiments shown in FIGS. 1 and 4-6, the light input edge 110 of the light guide includes light input regions, each input region associated with a respective light guide region. In the examples shown in FIGS. 1 and 4-6, the light input edge includes light input regions 110A, 110B, 110C. In some embodiments, the number of light input regions may correspond to the number of light guide regions. For example, in FIGS. 1 and 4-6 where the light source 104 is located on one side of the lighting assembly, the number of light input regions may be the same as the number of light guide regions. In other embodiments where the light source is located on more than one side of the light guide (e.g., opposite sides, such as that shown in FIG. 11), the number of light input regions may be more than the number of light guide regions.

As described above, the light source 104 includes solid-state light emitters 118. In the embodiments shown, the light source 104 includes light source segments, each light source segment associated with a given light guide region and having a grouping of one or more solid-state light emitters 118 that may be controlled (e.g., by the controller 121) to input light into a given light input region. In the example shown in FIG. 1, the solid-state light emitters 118 are provided on a single PCB 120, but the solid-state light emitters 118 are divided into groups of four solid-state light emitters, with each group constituting a light source segment 104A, 104B, 104C that is associated with a respective light guide region 102A, 102B, 102C. In other embodiments, each light source segment 104 may include any suitable number of solid-state light emitters (e.g., more or less than 4), and the light source segments may respectively include the same or a different number of solid-state light emitters 118. The number of solid-state light emitters provided in a given light source segment may depend, for example, on the size of the associated light guide region, the intensity of light to be extracted from the light guide region, and the like. Furthermore, as exemplified in FIGS. 4-6, the light source segments may be provided on more than one PCB. As shown in FIGS. 4-6, each light source segment 104A, 104B, 104C is provided on its own respective PCB 120.

Light emitted from a given light source segment may be incident a respective one of the light input regions, may enter the light guide, and may be emitted from the associated light guide region. For example, if the light source segment 104A of solid-state light emitters associated with light guide region 102A is controlled to emit light into the light guide, light may enter the light guide through the light input segment 110A of the input edge and propagate in the light guide region 102A where it is extracted from the light guide in a light output distribution defined by the light extracting elements in region 102A.

The controller 121 of the lighting assembly may be configured to selectively control the illumination state of the solid-state light emitters 118. As an example, the controller may selectively control the ON/OFF state of the solid-state light emitters 118. In some embodiments, the controller may control the ON/OFF state of the respective light source segments independent of one another. For example, with reference to FIG. 1, the light source segment 104A associated with light guide segment 102A may be controlled so as to be in an ON state, where light source segments 104B and 104C may be controlled so as to be in an OFF state. In another example, the light source segment 104A associated with light guide segment 102A and the light source segment 104C associated with light guide segment 102C may be controlled so as to be in an ON state, where light source segment 104B may be controlled so as to be in an OFF state. In some embodiments, the controller may control the ON/OFF state of respective solid-state light emitters within a given light source segment. In some embodiments, the controller may be configured to selectively dim the solid-state light emitters (e.g., all of the solid-state light emitters within a given light source segment and/or specific solid-state light emitters within a given light source segment). Accordingly, controlling the illumination state of the solid-state light emitters 118 may include controlling the intensity/dimming of the solid-state light emitters 118.

The lighting assemblies of the present disclosure may provide versatility with respect to the light output therefrom. In some embodiments, such versatility may be at least in part provided by different light output distributions that may be provided by the different light guide regions, together with control of the light source (e.g., provided by the controller 121).

The light extracting elements 124 of each respective light guide region are configured to output light in a defined light output distribution. In some embodiments, the defined light output distribution for a given light guide region may be different than the light output distribution for one or more of the other respective light guide regions. In an example, each respective light guide region may be configured to output light in a defined light output distribution different from the other light guide regions. Control of the light source segments via the controller 121 may provide different respective light output distributions being emitted from the lighting assembly.

For example, each light guide region may be configured to produce a specific distribution that can be used by itself, or the respective distributions from multiple light guide regions can be collectively utilized by illuminating more than one light guide region. In an example, light guide region 102A may provide a relatively narrow output distribution; light guide region 102B may provide an output distribution that is wider than the output distribution of light guide region 102A; and light guide region 102C may provide an output distribution that is wider than the output distribution of either of light guide regions 102A or 102B. If a narrow light output distribution is desired, the light source may be controlled by the controller to only emit light from the solid-state light emitters of light source segment 104A associated with region 102A. If a wide light output distribution is desired, the light source may be controlled by the controller to only emit light from the solid-state light emitters of light source segment 104C associated with region 102C; or may be controlled to emit light from all three light source segments 104A, 104B 104C so as to illuminate all three regions (to collectively produce the light output distribution). Hence, the regions can be utilized in an individual or collective manner.

One exemplary implementation of such a lighting assembly is in the context of general lighting for a room, where the lighting assembly can provide different light output distributions depending on how the room is being utilized. For example, the lighting assembly used as an overhead light in a conference room may provide a narrow light output distribution focused on an object such as the conference table (e.g., which may be suitable during a presentation), and may provide a wide light output distribution for ambient lighting in the room (e.g., which may be suitable during a general meeting).

In some embodiments, each of the solid-state light emitters 118 of the light source 104 emit light having nominally the same spectrum. Accordingly, nominally the same spectrum of light may be input to the respective light guide regions. In one example, nominally the same spectrum of light may be emitted from the respective light guide regions, and the regions may provide different respective light output distributions. Control of the light source segments may result in different light output distributions of light.

In other embodiments, the solid-state light emitters 118 of the light source 104 may have different respective emission spectrums. In one example, each of the solid-state light emitters in a given light source segment may emit light having nominally the same spectrum, and the spectrum of a given light source segment (e.g., segment 104A) may be different than the spectrum of one or more of the other light source segments (e.g., segment 104B and segment 104C). Control of the light source segments may result in light of different respective spectra being output from different light guide segments. In another example, the solid-state light emitters within a given light source segment may have different respective spectrums, and the solid-state light emitters for a given light source segment may be controlled to vary the spectrum of light emitted and input to a given light guide region.

Accordingly, the versatility provided by the lighting assembly may be at least in part be provided by different output spectrums of the light source segments, together with control of the light source (e.g., provided by the controller 121).

In some embodiments, the respective light output distributions for the light guide regions may be nominally the same, and control of the light source segments may result in light of different respective spectrums being output from different light guide regions. For example, the solid-state light emitters of the first light source segment may emit light having a first spectrum; the solid-state light emitters of the second light source segment may emit light having a second spectrum different than the first spectrum; and the solid-state light emitters of the third light source segment may emit light having a third spectrum different than the first spectrum and the second spectrum. With exemplary reference to FIGS. 1 and 4-6, each of the light guide segments 102A, 102B, 102C may provide nominally the same light output distribution. The light source segment 104A associated with light guide region 102A may include solid-state light emitters that emit light within a range of about 400 nm to about 500 nm; the light source segment 104B associated with light guide region 102B may include solid-state light emitters that emit light within a range of about 600 nm to about 700 nm; and the light source segment 104C associated with light guide segment 102C may include solid-state light emitters that emit light within a range of about 700 nm to about 800 nm. Control of the different respective light source segments 104A, 104B, 104C may output different color light from the lighting assembly, with the light being output from the respective light guide regions at nominally the same light output distribution. For example, the light source segment 104A may be controlled so as to be in an ON state, where light source segments 104B and 104C may be controlled so as to be in an OFF state; and this may result in light emitted from the lighting assembly within a range of about 400 nm to about 500 nm. Similar to that described above, the light source segments may be individually or collectively illuminated.

In other embodiments, control of the different output spectrums may be provided in combination with control of the different light output distributions. The respective light output distributions for the light guide regions may differ from one another, and control of the light source segments may result in light of different respective spectrums being output from different light guide regions, the light guide regions providing different light output distributions. In examples where each of the solid-state light emitters in a given light source segment may emit light having nominally the same spectrum and the spectrum of a given light source segment is different than the spectrum of other light source segments, a particular color temperature (spectrum) may be associated with a given output distribution. For example, a light source segment that emits cool light may be associated with a light guide region that provides a narrow light output distribution; and a light source segment that emits warm light may be associated with a light guide region that provides a wide light output distribution. In examples where the solid-state light emitters in a given light source segment differ from one another with respect to output spectrum, the individual solid-state light emitters of a given light source segment may be controlled by the controller to input light having one of several possible spectrums into the light guide region (e.g., by turning ON or OFF individual solid-state light emitters 118 within the given light source segment).

One exemplary implementation of a lighting assembly providing varied output spectrum and light output distribution is in the context of grow lights (e.g., for plant growth), where the lighting assembly may provide different light output distributions and/or spectrum output during different stages of plant growth and development, and/or during different times of the day. As an example, multiple types of solid-state light emitters including monochromatic, phosphor-converted, and various mixes of the two may be provided in each light source segment in order to tune the spectrum of emitted light such as to elicit an optimized plant growth response. Some commonly used monochromatic wavelengths used for plant growth response are 450 nm, 660 nm, and 730 nm. The different light guide regions may also provide narrower or wider distributions of this output light, depending on the size/development stage of the plants.

Another exemplary implementation of a lighting assembly providing varied output spectrum and light output distribution is in the context of an examination room or operating room (e.g., in the medical field), where the lighting assembly may provide a diffuse warm light output distribution throughout the room; and may also be used to provide a more directional distribution of cooler light that can be used to provide lighting during examinations and other tasks that require focused lighting.

As described above, the lighting assembly may include a housing that retains the light guide. In some embodiments, the light guide may be mechanically fixed to and retained by the housing such that the light input edge is adjacent the solid-state light emitters. As an example, the light guide may be fixedly attached to the housing by a fastener such as one or more screws.

In other embodiments, and with reference to FIGS. 7 and 8, the lighting assembly may be configured such that the light guide(s) and light guide segment(s) are interchangeable. This may further increase the versatility of the lighting assembly by allowing the light guide(s) (or light guide segments(s)) to be changed in the field to meet changing requirements. By changing a light guide or light guide segment in a given lighting assembly, parameters such as the size (e.g., length) of light guide or light guide segment, and/or the output distribution provided by the light guide or light guide segment may be modified according to a given need.

FIGS. 7 and 8 show an exemplary embodiment in which light guide segments 102A and 102B collectively form the light guide 102 and are retained by the housing 122. It will be appreciated that while FIGS. 7 and 8 exemplify the light guide as being collectively formed by light guide segments that are individually retained and removable from the housing, in other embodiments, other implementations of the light guide 102 such as that shown in FIGS. 1 and 4-6 may be retained by the housing in a similar manner to that shown in FIGS. 7 and 8.

In the example shown in FIGS. 7 and 8, the sides of each light guide segment 103A, 103B (e.g., proximate the light input edge 110) include a notch 144. The housing 122 includes a light guide retention slot 148 (FIG. 8) including protrusions 146 (FIG. 7) that may respectively cooperate with the notches 144 to retain the light guide segment. The light guide segments are partially disposed in the light guide retention slot 148 such that the notches 144 of the light guide cooperate with the protrusions 146 and the light guide segments are retained by the housing 122. The light guide segments may be removed from the housing 122 by releasing the notches 144 of the light guide segment from the protrusion 146 (e.g., by pulling the light guide segment from the housing or by actuating a release mechanism such as a lever or motor, not shown) that moves the protrusions 146 away from the notches 144.

In an example, the lighting assembly having interchangeable light guides or light guide segments could be designed with different light guide lengths for the grow light applications. Shorter light guides with narrow distributions could be used for early stages of plant growth. Longer light guides with wide distributions could be used for later growth stages to provide light over the larger surface area of the plants.

In some embodiments, although not specifically shown, the housing may also provide the ability to rotate the light guide segments with respect to one another to further enhance the ability to meet distribution requirements. For example, with reference to FIG. 7, the housing may include housing segments that may be rotationally adjusted and/or positioned relative an axis extending parallel to direction 115 so that the light guides may be arranged in a particular arrangement relative to one another.

FIGS. 9 and 10 show exemplary embodiments of the lighting assembly 100 implemented in a vertical orientation (and as such may also be referred to as a vertical blade lighting assembly/fixture). In FIG. 9, the lighting assembly includes a pole 121 attached to the housing 122 for mounting the lighting assembly to the retaining structure. In FIG. 10, the lighting assembly includes a base (stand) 123 for providing the lighting assembly in the vertical orientation. Embodiments of the lighting assembly provided in a vertical blade fixture arrangement may provide one or more advantages in addition to the versatility described above with respect to the light output (light output distribution and/or spectrum). For example, in the area of plant growth, the narrow footprint may not obstruct sun light like a horizontal fixture in applications where the sun is used during the day for the growing cycle. The light guide regions may also be configured to emit light may also exit one or both sides of the light guide.

In some embodiments of the lighting assembly 100 such as that shown in FIGS. 9 and 10 where the end edge 112 of the light guide is exposed, the light guide may also include an optical element (e.g., one or more lenticular elements or other suitable light redirecting features) at the end edge of the light guide distal the light input edge. This optical element may redirect light extracted from the light guide through the end edge in a desired light output distribution. Optical elements provided at the end edge 112 may be the same for each light guide region, or may differ by light guide region.

Of course, in other embodiments, the lighting assembly can be used in any other suitable orientation (e.g., horizontal or angled) depending on the particular application. As an example, the lighting assembly may be used in a troffer or by itself in a horizontal or angled arrangement where a mounting mechanism may mount the lighting assembly to the retaining structure (e.g., ceiling or wall). In some embodiments, the lighting assembly oriented in the horizontal or angled arrangement may include a reflector to redirect light exiting one of the surfaces (e.g., the top surface) back through the light guide.

FIG. 11 shows another exemplary embodiment of the lighting assembly 100. The exemplary embodiment shown in FIG. 11 can be oriented in a vertical, horizontal, or angled arrangement. In FIG. 11, the housing and light source segments are provided at both edge 110 and edge 112 of the light guide. As shown, light source segment 104A is adjacent edge 110 and associated with light guide region 102A; light source segment 104C is adjacent edge 112 and associated with light guide region 102A; light source segment 104B is adjacent edge 110 and associated with light guide region 102B; and light source segment 104D is adjacent edge 112 and associated with light guide region 102B. Each light guide region 102A, 102B can be lit from one or both edges. As described in the embodiments above, the light guide regions 102A, 102B may be configured to provide either nominally the same different respective light output distributions. Furthermore, the controller may control the light source segments 104A, 104B, 104C, 104D to vary the illumination state (e.g., ON/OFF and or brightness/dimming) and/or the spectrum of the light guide regions. In some embodiments, the light source segments associated with a given region may be the same. For example, the light source segment 104A at the edge 110 of light guide region 110A may provide the same spectrum as the light source segment 104C at the edge 112 of the light guide region 110A. In some embodiments, the light source segments associated with a given region may be the different. For example, the light source segment 104A at the edge 110 of light guide region 110A may provide a different spectrum as the light source segment 104C at the edge 112 of the light guide region 110A, and these light source segments may be used individually or collectively to provide a desired output spectrum of the light emitted from light guide region 102A.

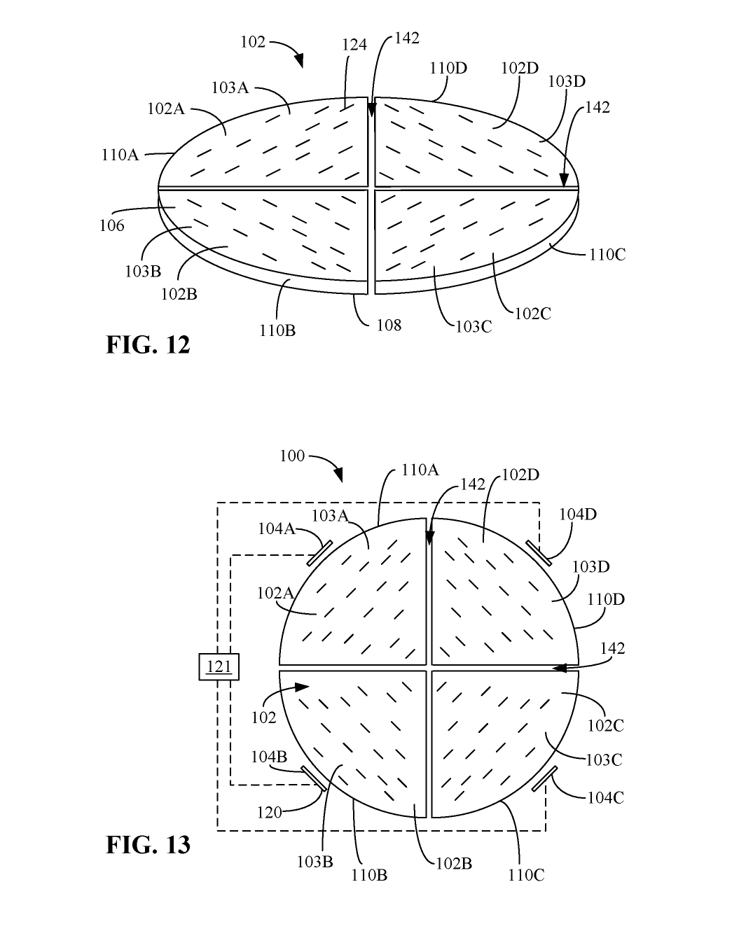

Turning now to FIGS. 12 and 13, another exemplary embodiment of the light guide and lighting assembly is shown. In FIGS. 12 and 13, the light guide 102 is embodied as a circular light guide having light guide segments 103A, 103B, 103C, 103D that collectively form the light guide. Each light guide segment may constitute its own distinct light guide region 102A, 102B, 102C, 102D (e.g., Zone 1, Zone 2, and Zone 3, Zone 4). In the embodiment shown, the slot 142 between adjacent light guide regions may be embodied as an air gap. Light input to and propagating in a given light guide region that is incident the edge surface adjacent the slot may internally reflect and continue to propagate in the region. In some embodiments, an element such as a reflector or material having a different refractive index than the light guide regions may be disposed in the slot 142 to redirect extracted light back into the light guide region.

With specific reference to FIG. 13, the lighting assembly includes respective light source segments 104A, 104B, 104C, 104D adjacent respective input edges 110A, 110B, 110C, 110D of the light guide regions 102A, 102B, 102C, 102D. Light output from a respective light source segment (e.g., 104A) may be input to the associated light guide segment via the input edge (e.g., 110A), and may be extracted from the associated light guide region (e.g., 102A). While the edge surface 110 of the light guide is shown as a curved surface, in some embodiments, one or more portions of the edge surface 110 may be planar for purposes of inputting light to the light guide.

FIG. 13A shows an exemplary embodiment of the lighting assembly with the light guide 102 embodied as a circular light guide, wherein the light source segments 104A, 104B, 104C, 104D each include a substrate 125 that conforms to the curved surface 110A, 110B, 110C, 110D of the light guide. The substrate 125 may be a flexible and/or conformable member (e.g., a tape) on which the solid-state light emitters of the light source segment may be mounted. It will be appreciated that embodiments of the light source segments described in both the lighting assembly embodiments set forth above and the lighting assembly embodiments described below can include a substrate 125 such as that described in the context of FIG. 13A, regardless of whether the edge surface of the light guide adjacent the light source segment is curved or planar.

The configuration of the light guide regions, configuration of the light source segments, and control of the lighting assembly shown in FIG. 13 may be similar to that which is described above with respect to the other embodiments of the lighting assembly. For example, in some embodiments, the defined light output distribution for a given light guide region may be different than the light output distribution for one or more of the other respective light guide regions. In other embodiments, the defined light output distribution for the light guide regions may be nominally the same. In some embodiments, each of the solid-state light emitters of the light source emit light having nominally the same spectrum. In other embodiments, the solid-state light emitters of the light source may have different respective emission spectrums. In one example, each of the solid-state light emitters in a given light source segment may emit light having nominally the same spectrum, and the spectrum of a given light source segment may be different than the spectrum of one or more of the other light source segments. In another example, the solid-state light emitters within a given light source segment may have different respective spectrums, and the solid-state light emitters for a given group may be controlled to vary the spectrum of light emitted and input to a given region.

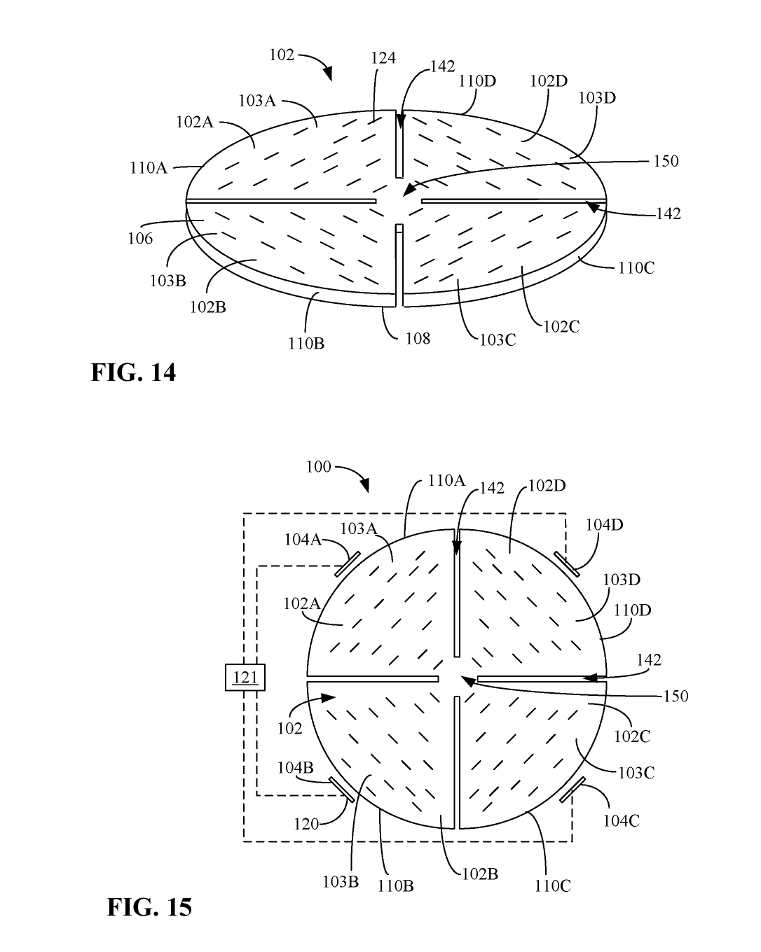

FIGS. 14 and 15 show another exemplary embodiment of the light guide and lighting assembly. The light guide and lighting assembly is similar to the embodiments described above and shown in FIGS. 12, 13, and 13A, but the light guide in the embodiment of FIGS. 14 and 15 is embodied as a single (e.g., monolithic) element in which adjacent light guide regions of the light guide partially separated from one another, but the light guide regions are joined at a central region 150.

As shown, the slots 142 partially extend between the input edge and the center of the circle. The slots may minimize light crossing over into an adjacent light guide region. In the embodiment shown, a slot 142 between adjacent light guide regions may be embodied as an air gap. Light input to and propagating in a given light guide region that is incident the edge surface adjacent the slot may internally reflect and continue to propagate in the region. In some embodiments, an element such as a reflector or material having a different refractive index than the light guide regions may be disposed therein to redirect extracted light back into the light guide region.

The configuration of the light guide regions, configuration of the light source segments, and control of the lighting assembly shown in FIG. 15 may be similar to that which is described above

In some embodiments, the lighting assembly 100 may include a cover element adjacent one of the major surfaces 106, 108 of the light guide. The cover element may increase the versatility of the lighting assembly by modifying the light output from one or more of the light guide regions.

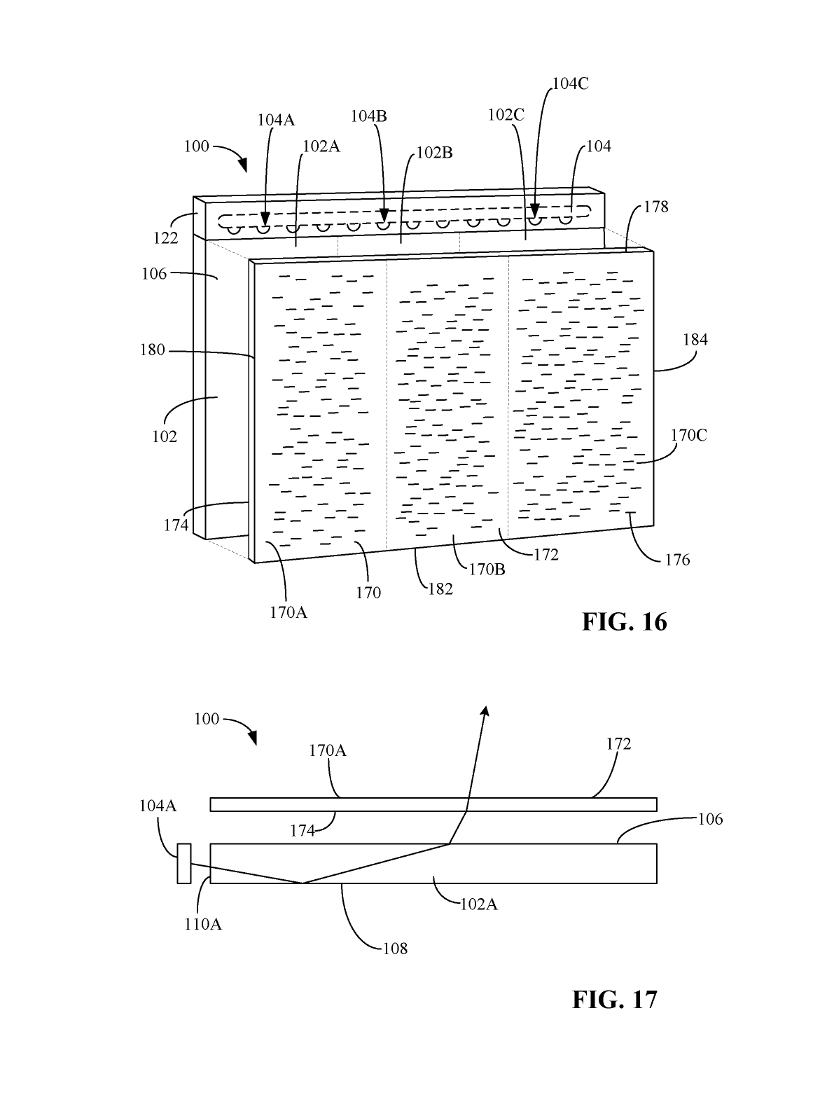

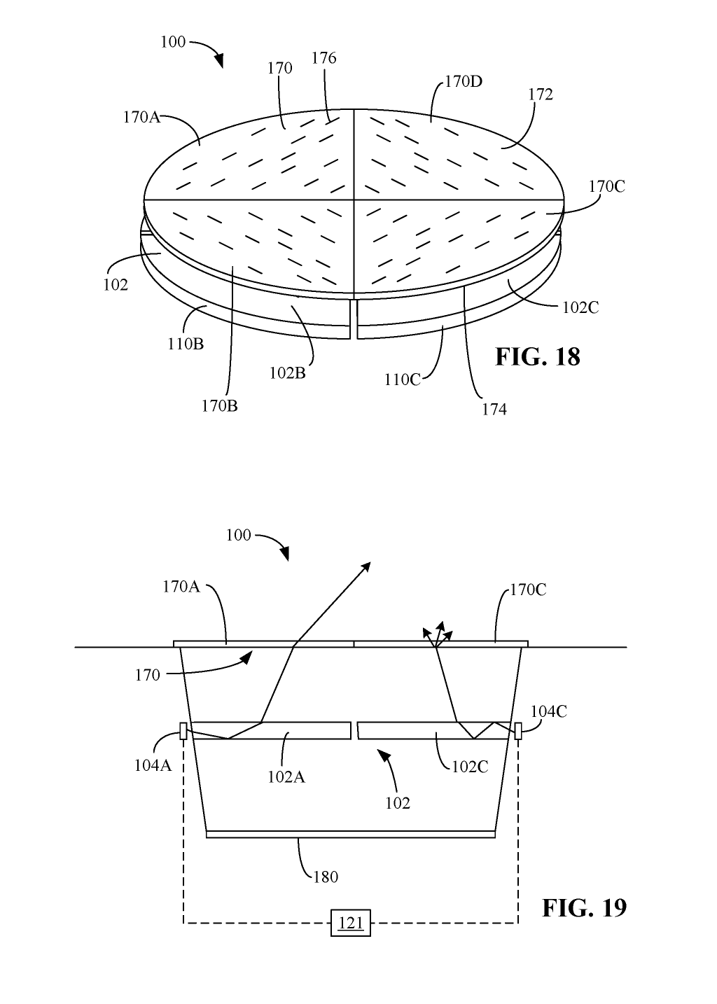

FIGS. 16 and 17 show an exemplary embodiment of a lighting assembly in which the light guide is embodied as a rectangular light guide (e.g., similar to that shown in FIG. 1), and a cover element 170 is adjacent the light guide. FIGS. 18 and 19 show an exemplary embodiment of a lighting assembly in which the light guide is embodied as a circular light guide (e.g., similar to that shown in the embodiments of FIG. 12-15), and a cover element 170 is adjacent the light guide.

The cover element may be a solid article of manufacture (e.g., a substrate) made from, for example, polycarbonate, poly(methyl-methacrylate) (PMMA), glass, or other appropriate material; and may include a first major surface 172 and a second major surface 174 opposite the first major surface. A major surface 172, 174 of the cover element may be located adjacent one of the major surfaces 106, 108 of the light guide 102. At least one edge surface extends between the major surfaces 172 174 of the cover element (e.g., in the thickness direction 119). The total number of edge surfaces depends on the configuration of the cover element 170. The configuration of the cover element may correspond to the configuration of the light guide such that a major surface of the cover element conforms to the shape of the adjacent major surface of the light guide. For example, in the case where the light guide is rectangular (FIG. 16), the cover element 170 may also be rectangular with four edge surfaces 178, 180, 182, 184. In another example, in the case where the light guide is circular (FIG. 18), the cover element 170 may also be circular. In the embodiments shown in FIGS. 16-19, the major surfaces of the cover element are planar. In other embodiments, at least a portion of the major surfaces of the cover element is curved in one or more directions.

As shown in FIGS. 17 and 19, the light extracted through the major surface of the light guide adjacent the cover element may pass through the cover element. The cover element includes cover element regions 170A, 170B, 170C, 170D that are aligned with the respective light guide regions 102A, 102B, 102C, 102D of the light guide. At least one of the cover element regions 170A, 170B, 170C, 170D include one or more optical modifying characteristics that may modify light passed therethrough. Exemplary optical modifying characteristics include reflective, diffusive, light redirecting, polarizing, reflective polarizing, intensity reducing, wavelength shifting and color attenuating characteristics. Wavelength shifting is used herein to refer to a process in which a material absorbs light at certain wavelengths, and reemits the light at one or more different wavelengths. Wavelength shifting may be achieved using a phosphor material, a luminescent material, a luminescent nanomaterial such as a quantum dot material, a conjugated polymer material, an organic fluorescent dye, an organic phosphorescent dye, lanthanide-doped garnet, or the like. Color attenuating may be achieved using color filtering material. In some embodiments, each of the cover element regions 170A, 170B, 170C, 170D include one or more optical modifying characteristics that may modify light passed therethrough. In other embodiments, one or more of the cover element regions 170A, 170B, 170C, 170D may be specularly transmissive such that it provides no optical modifying characteristic to the light passing therethrough.

As exemplified by the embodiment shown in FIGS. 16 and 18, each of the cover element regions may include one or more optical modifying characteristics. In the example shown, the cover element regions each include light redirecting elements 176. The one or more optical modifying characteristics of the respective cover element regions may be the same or may differ from one another.

FIG. 19 shows an exemplary embodiment of the lighting assembly embodied as a recessed lighting assembly. The light source segments (of which 104A and 104C are shown in FIG. 19) may be controlled by the controller 121 to input light into the respective light guide regions of the light guide. For example, light input to light guide region 102A from light source segment 104A may propagate in the light guide region 102A and may be extracted from the major surface of the light guide. Light input to light guide region 102C from light source segment 104C may propagate in the light guide region 102C and may be extracted from the major surface of the light guide. The cover element is arranged adjacent the light guide such that the light extracted from light guide region 102A is incident and passes through cover element region 170A, and such that the light extracted from light guide region 102C is incident and passes through cover element region 170C. In the example shown, cover element region 170A is configured to specularly redirect the light passing therethrouh, while cover element region 170C is configured to scatter light passing therethrough. Depending on the control of the light source segments, the lighting assembly may therefore emit specular or diffuse light. In the example shown, the lighting assembly may include a reflector 180 adjacent major surface 108 of the light guide for reflecting light extracted through the major surface 108 back through the light guide. The reflector 180 may be a specular reflector, a diffuse reflector, or a patterned reflector.

In the embodiments shown in FIGS. 16-19, the cover element is a single (e.g., monolithic) element. In other embodiments, the cover element may include two or more cover element segments that collectively form the cover element. Furthermore, in while the cover elements shown in FIGS. 16 and 18 include a corresponding cover element region for each light guide region, in some embodiments, the cover element may only be adjacent a portion of the light guide regions. For example, light extracted from one or more light guide regions of the light guide may pass through the cover element, while light extracted from one or more other light guide regions of the light guide may exit the lighting assembly without being passed through the cover element.

Although not specifically shown, in some embodiments where light is extracted from both major surfaces 106, 108 of the light guide, the lighting assembly may include at least two cover elements, one cover element adjacent the major surface 106 and another cover element adjacent the major surface 108. In some embodiments, the cover elements may be the same. In other embodiments, the cover elements may differ, for example, with respect to the optical modifying characteristic(s) imparted to the light passed therethrough.

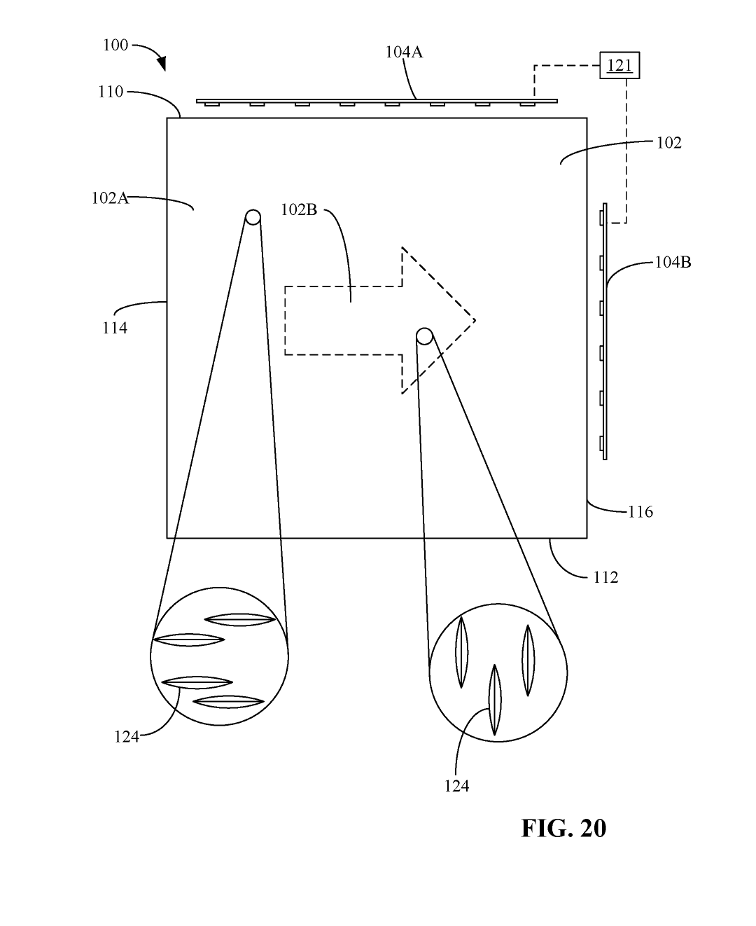

In embodiments described above, the light guide regions of the light guide may be arranged adjacent one another. In other embodiments such as that shown in FIG. 20, the light guide regions may be arranged in a manner such that one light guide region is at least partially encompassed by another light guide region. In the example shown, a first light guide region 102A surrounds a second light guide region 102B that is shaped as an arrow. In other embodiments, the light guide region that is at least partially surrounded by the surrounding region may be provided as any suitable shape.

The lighting assembly 100 includes a first light source segment 104A located at side edge 110 and a second light source segment 104B located at side edge 116. In the example shown, side edges 110 and 116 are perpendicular to one another. The first light source segment 104A is associated with first light guide region 102A and the second light source segment 104B is associated with the second light guide region 102B. But due to the arrangement of the regions, light input to the light guide region 102A also propagates in the light guide region 102B. Also, light input to the light guide from light source segment 104B must pass through light guide region 102A to reach light guide region 102B.

As shown in FIG. 20, the light extracting elements 124 of the respective light guide regions 102A, 102B may be configured and/or arranged such that the light extracting elements within a given light guide region primarily extract light input to the light guide from the light source segment that is associated with the given light guide region. For example, in some embodiments, the light extracting elements 124 of light guide region 102A extract at least 80% of the light input to the light guide from light source segment 104A, and extract less than 10% of the light input to the light guide from light source segment 104B; and the light extracting elements 124 of light guide region 102B extract at least 80% of the light input to the light guide from light source segment 104B, and extract less than 10% of the light input to the light guide from light source segment 104A. In the example shown, the light extracting elements in light guide regions 102A, 102B are embodied as football shapes, with their ridges arranged parallel (or near parallel, e.g., ±15°) to the light input edge associated with the light guide region in which the light extracting elements are located. For example, the ridge of the light extracting elements located in light guide region 102A are arranged parallel (or near parallel, e.g.,) ±15° to the edge 110; and the ridge of the light extracting elements located in light guide region 102B are arranged parallel (or near parallel, e.g., ±15°) to the edge 116.

The light source segments may be controlled by the controller 121 in a manner similar to that described above. As an example, the controller may turn ON the solid-state light emitters of light source segment 104A, and may keep OFF the solid-state light emitters of light source segment 104B. This may illuminate the light guide region 102A surrounding the arrow, but the arrow region 102B itself may not be illuminated. As another example, the controller may turn ON the solid-state light emitters of light source segment 104B, and may keep OFF the solid-state light emitters of light source segment 104A. This may illuminate the arrow region 102B, but not the light guide region 102A surrounding the arrow region. As another example, the controller may turn ON the solid-state light emitters of both light source segment 104A and 104B. This may illuminate both the arrow region 102B and the region 102A surrounding the arrow region.

In some embodiments, the solid-state light emitters of light source segment 104B may emit light having a different spectrum than the solid-state light emitters of light source segment 104A. As an example, the solid-state light emitters of light source segment 104B may emit red light, whereas the solid-state light emitters of light source segment 104A may emit white light. Accordingly, turning ON the solid-state light emitters of light source segment 104B may result in illuminating a red arrow and turning ON the solid-state light emitters of light source segment 104A may result in illumination a white region surrounding the arrow.

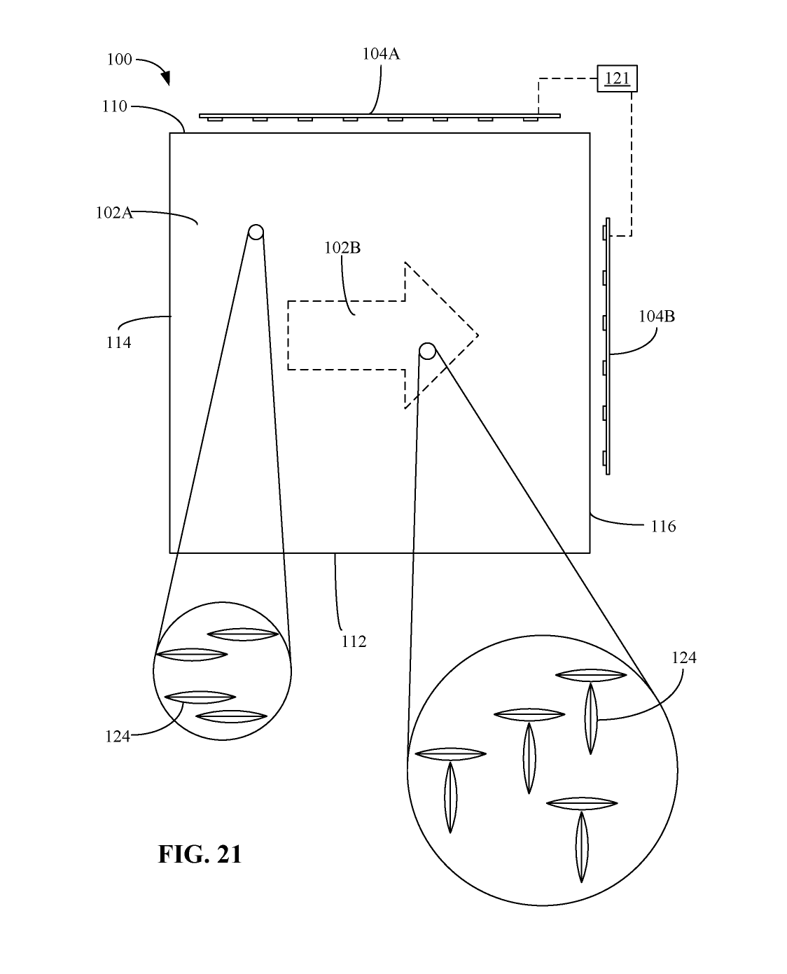

FIG. 21 shows an embodiment similar to that shown in FIG. 20, but wherein the light guide region 102A overlaps light guide region 102B. Accordingly, both light guide region 102A and light guide region 102B are provided in the arrow shaped region shown in FIG. 21. As shown, light extracting elements 124 are provided in the arrow shaped region with their ridges arranged parallel (or near parallel, e.g., ±15°) to the edge 116, and are configured to extract light input to the light guide from light source segment 104B. Other light extracting elements 124 are provided in in the arrow shaped region with their ridges arranged parallel (or near parallel, e.g., ±15°) to the edge 110, and are configured to extract light input to the light guide from light source segment 104A. The light extracting elements present in light guide region 102B are also arranged in such a manner that the light extracting elements configured to extract light input to the light guide from light source segment 104A may shadow the light extracting elements configured to extract light input to the light guide from light source segment 104B. This may reduce the amount of light input to the light guide from the light source segment 104A that is extracted from the light extracting elements 124 provided with their ridges arranged parallel (or near parallel, e.g., ±15°) to the edge 116.

The light source segments may be controlled by the controller 121 in a manner similar to that described above. Furthermore, the solid-state light emitters of light source segment 104B may emit light having a different spectrum (e.g., red) than the solid-state light emitters of light source segment 104A (e.g., white). As an example, the controller may turn ON the solid-state light emitters of light source segment 104A, and may keep OFF the solid-state light emitters of light source segment 104B. This may illuminate the region surrounding the arrow, as well as the arrow region with white light. As another example, the controller may turn ON the solid-state light emitters of light source segment 104B, and may keep OFF the solid-state light emitters of light source segment 104A. This may illuminate the arrow region with red light, but not the region surrounding the arrow region. As another example, the controller may turn ON the solid-state light emitters of both light source segment 104A and 104B. This may illuminate both the arrow region in red and the region surrounding the arrow region in white.

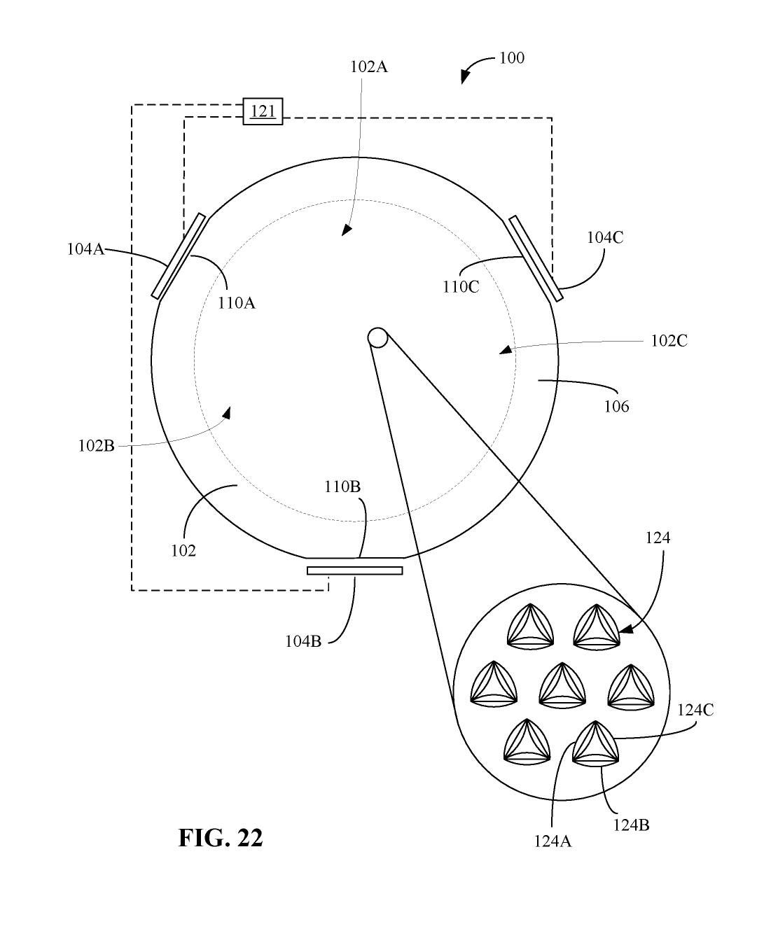

FIG. 22 shows another exemplary embodiment of the lighting assembly that includes three light guide regions 102A, 102B, 102C overlapped with one another. As shown in light guide region, light extracting elements 124A of the light guide region 102A are provided with their ridges arranged parallel (or near parallel, e.g., ±15°) to input edge segment 110A, and are configured to extract light input to the light guide from light source segment 104A. Other light extracting elements 124B of the light guide region 102B are provided with their ridges arranged parallel (or near parallel, e.g., ±15°) to input edge segment 110B, and are configured to extract light input to the light guide from light source segment 104B. Other light extracting elements 124C of the light guide region 102C are provided with their ridges arranged parallel (or near parallel, e.g., ±15°) to input edge segment 110C, and are configured to extract light input to the light guide from light source segment 104C. The light extracting elements present in the overlapped light guide regions are also arranged in such a manner that the light extracting elements configured to extract light input to the light guide from one light source segment may shadow the light extracting elements configured to extract light input to the light guide from one or more of the other light source segments. As shown, a set of three light extracting elements are arranged in a triangular manner. This arrangement may reduce the amount of light input to the light guide from one light source segment (e.g., 104A) that is extracted from the light extracting elements 124 associated with the other light source segments (e.g., 104B, 104C).

The light source segments may be controlled by the controller 121 in a manner similar to that described above. Furthermore, the solid-state light emitters of the respective light source segment may emit light having different respective spectrums. As an example, light source segment 104A may emit red light, light source segment 104B may emit yellow light, and light source segment 104C may emit blue light. The controller may control operation of the light source segments to obtain a light output having a desired spectrum. For example, the controller may turn ON the solid-state light emitters of light source segment 104A, and may keep OFF the solid-state light emitters of light source segments 104B and 104C. As another example, the controller may turn ON the solid-state light emitters of light source segments 104B and 104C, and may keep OFF the solid-state light emitters of light source segment 104A. This may provide a combined spectrum of light that is output from the lighting assembly. As another example, the controller may turn ON the solid-state light emitters of all of light source segments 104A, 104B, and 104C. The controller may also dim the light source segments and/or control the operation state or dimming of individual solid-state light emitters within the light source segments in order to provide a combined desired output spectrum of the light.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A lighting assembly, comprising:
a light guide comprising:
a first major surface;
a second major surface opposed the first major surface;
at least one light input edge extending between the first major surface and the second major surface, the first major surface and the second major surface configured to propagate light input to the light guide through the at least one light input edge therebetween by total internal reflection, the at least one light input edge comprising a first light input region and a second light input region;
a first light guide region comprising first light extracting elements at at least one of the major surfaces, the first light guide region configured to extract light input to the light guide through the first light input region; and
a second light guide region comprising second light extracting elements at at least one of the major surfaces, the second light guide region configured to extract light input to the light guide through the second light input region;
a light source adjacent the at least one light input edge, the light source comprising a first light source segment of solid-state light emitters and a second light source segment of solid-state light emitters, the first light source segment arranged to input light through the first light input region and into the first light guide region, the second light source segment arranged to input light through the second light input region and into the second light guide region, the first light source segment and the second light source segment independently controllable to control an illumination state of the solid-state light emitters.

2. The lighting assembly of claim 1, wherein an ON/OFF state of the first light source segment is controlled independent of the ON/OFF state of the second light source segment.

3. The lighting assembly of claim 1, wherein the first light source segment is dimmable independent of the second light source segment.

4. The lighting assembly of claim 1, wherein an ON/OFF state of the respective solid-state light emitters within the first light source segment are controlled independent of one another and an ON/OFF state of the respective solid-state light emitters within the second light source segment are controlled independent of one another.

5. The lighting assembly of claim 1, wherein respective solid-state light emitters within the first light source segment are dimmable and respective solid-state light emitters within the second light source segment are dimmable.

6. The lighting assembly of claim 1, further comprising a controller configured to selectively control the illumination state of the solid-state light emitters of first light source segment and the second light source segment.

7. The lighting assembly of claim 1, wherein each of the solid-state light emitters emit light have nominally the same spectrum.

8. The lighting assembly of claim 1, wherein the solid-state light emitters of the first light guide segment emit light at a different spectrum than the second group of solid-state light emitters.

9. The lighting assembly of claim 1, wherein the solid-state light emitters of the first group emit light at different respective spectrums.

10. The lighting assembly of claim 1, wherein the first light source segment comprises solid-state light emitters configured to emit light at about 400 nm to about 500 nm, and the second light source segment comprises solid-state light emitters configured to emit light at about 600 nm to about 700 nm.

11. The lighting assembly of claim 1, wherein the first light extracting elements of the first light guide region are configured to output light in a first light output distribution, and the second light extracting elements of the second light guide region are configured to output light in a second light output distribution different than the first light output distribution.

12. The lighting assembly of claim 1, wherein the first light extracting elements of the first light guide region and the light extracting elements of the second light guide region are configured to output light in nominally the same light output distribution.

13. The lighting assembly of claim 1, wherein the light guide comprises a slot at least partially separating the first light guide region and the second light guide region.

14. The lighting assembly of claim 13, further comprising a reflective material disposed in the slot.

15. The lighting assembly of claim 1, wherein the light guide comprises light guide segments, one of the light guide segments comprising the first light guide region and another of the light guide segments comprising the second light guide region.

16. The lighting assembly of claim 1, wherein the first light guide region is adjacent the second light guide region, and each of the first light guide region and the second light guide region extend from the light input edge to an end edge opposite the light input edge.

17. The lighting assembly of claim 1, wherein the first light guide region at least partially surrounds the second light guide region.

18. The lighting assembly of claim 1, wherein the first light guide region at least partially overlaps the second light guide region.

19. The lighting assembly of claim 1, further comprising a housing configured to retain the light guide, wherein the light guide is removably attached to the housing.

20. The lighting assembly of claim 1, further comprising a cover element adjacent one of the major surfaces of the light guide, the cover element comprising a first cover element region aligned with the first light guide region and a second cover element region aligned with the second light guide region, at least one of the first and second cover element regions configured to impart an optical modifying characteristic to the light extracted from the light guide.
